(19) United States
(12) Patent Application Publication
(10) Pub. No.: US 2011/0119919 A1
(43) Pub. Date: May 26, 2011

(54) Determinant Assembly System for Manufacturing Objects

(75) Inventor: Phillip John Crothers, Hampton East (AU)

(73) Assignee: The Boeing Company, Chicago, IL (US)

(21) Appl. No.: 12/623,689

(22) Filed: Nov. 23, 2009

(51) Int. Cl. B21D 53/92; B23P 11/00

(52) U.S. Cl. 29/897.2; 29/428; 29/791

(57) ABSTRACT

A Method and apparatus may be present for processing parts. A first part may be positioned in a first position. A first number of features may be formed on the first part using a feature forming system at a number of points for attachment to a second part. The second part may be positioned in a second position relative to the first position for assembly of the first part with the second part. A second number of features may be formed on the second part at the number of points for attachment to the first part using the feature forming system.

### BACKGROUND INFORMATION

1. Field

The present disclosure relates generally to manufacturing and, in particular, to a method and apparatus for manufacturing objects with multiple parts. Still more particularly, the present disclosure relates to a method and apparatus for attaching parts to each other.

2. Background

Manufacturing aircraft may require large amounts of time and expense as compared to smaller or simpler objects. It may be desirable to reduce the amount of time needed to manufacture an aircraft. By reducing the amount of time needed to manufacture an aircraft, an aircraft manufacturer may deliver aircraft to customers more quickly and receive revenues for those aircraft more quickly.

In manufacturing an aircraft, time is involved in manufacturing parts for the aircraft and/or assembling the parts to form the aircraft. With respect to assembling parts, different parts may be secured to each other to form structures for the aircraft. For example, without limitation, skin panels, ribs, and spars may be attached to each other to form structures, such as a fuselage, wings, horizontal stabilizers, and other suitable structures for the aircraft. Parts also may be assembled to form other structures such as, for example, without limitation, an engine, an electrical system, a health monitoring system, a landing gear, and other suitable components.

One manner in which the time needed to assemble parts for an aircraft may be reduced is through the use of determinant assembly. Determinant assembly may allow for quicker assembly of parts for an aircraft as compared to other manufacturing processes. Determinant assembly is a process that uses features on the different parts to align the parts to each other for assembly. Determinant assembly may not require the use of other tools to aid in the alignment of parts to each other for assembly.

For example, holes may be drilled in two parts in the locations needed for assembly of those two parts to each other. Those parts may then be positioned relative to each other using the holes. A fastening system may then be placed through the holes to secure the two parts to each other. In other advantageous embodiments, the holes may merely serve as an alignment feature. With this type of assembly, other types of fastening mechanisms may be used such as, for example, without limitation, adhesive or other suitable materials. With this type of assembly, the holes may be used for pins or other structures, which may hold the parts in place for application and curing of the adhesive.

The matching features on the different parts may guide the positioning parts relative to each other in an assembly. The positioning of parts may require some amount of accuracy. This accuracy may be determined by the accuracy of the features formed in the parts. If the features are created at a location greater than some tolerance from the desired location, the parts may not fit correctly with each other. In other instances, the assembled parts in the structure may not function as desired.

Therefore, it would be advantageous to have a method and apparatus that takes into account at least one of the issues discussed above, as well as possibly other issues.

### SUMMARY

In one advantageous embodiment, a method may be present for processing parts. A first part may be positioned in a first position. A first number of features may be formed on the first part using a feature forming system at a number of points for attachment to a second part. The second part may be positioned in a second position relative to the first position for assembly of the first part with the second part. A second number of features may be formed on the second part at the number of points for attachment to the first part using the feature forming system.

In another advantageous embodiment, a method may be present for processing parts for an aircraft. A first part for the aircraft may be positioned in a first position using a positioning system. A first number of features may be formed on the first part at a number of points using a feature forming system controlled using a computer-based program and a number of paths to the number of points. A second part for the aircraft may be positioned in a second position relative to the first position for assembly of the first part with the second part using the positioning system. A second number of features may be formed on the second part at the number of points using the feature forming system controlled using the computer-based program and the number of paths to the number of points. The first number of features and the second number of features may be configured for attaching the first part and the second part to each other. The second number of features may be formed at the number of points in a substantially same order as the first number of features formed at the number of points. The feature forming system may comprise at least one of a drilling machine, a milling machine, and a lathe. The first number of features and the second number of features may be comprised of a number of holes.

In yet another advantageous embodiment, an apparatus may comprise a positioning system and a feature forming system. The positioning system may be configured to position a first part in a first position and a second part in a second position in which the second position may be relative to the first position for assembly of the first part with the second part. The feature forming system may be configured to form a first number of features on the first part at a number of points when the first part is in the first position and to form a second number of features on the second part at the number of points when the second part is in the second position. The first number of features and the second number of features may be for attaching the first part and the second part to each other.

In still yet another advantageous embodiment, an apparatus for forming features for determinant assembly of parts for an aircraft may comprise a positioning system and a feature forming system. The positioning system may be configured to position a first part for an aircraft in a first position and a second part for the aircraft in a second position in which the second position may be relative to the first position for assembly of the first part with the second part. The feature forming system may be configured to form a first number of features on the first part at a number of points using a number of paths to the number of points when the first part is in the first position and to form a second number of features on the second part at the number of points using the number of paths to the number of points when the second part is in the second position. The first number of features and the second number of features may be for attaching the first part and the second part to each other. The feature forming system may comprise at least one of a drilling machine, a milling machine, and a lathe. The first number of features and the second number of features may be comprised of a number of holes.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of an aircraft manufacturing and service method in accordance with an advantageous embodiment;

FIG. 2 is an illustration of an aircraft in which an advantageous embodiment may be implemented;

FIG. 3 is an illustration of an object manufacturing environment in accordance with an advantageous embodiment;

FIG. 4 is an illustration of a drilling machine in accordance with an advantageous embodiment;

FIG. 5 is an illustration of a positioning of parts in a manufacturing environment in accordance with an advantageous embodiment;

FIG. 6 is an illustration of a positioning of parts in a manufacturing environment in accordance with an advantageous embodiment;

FIG. 7 is an illustration of a positioning of parts in a manufacturing environment in accordance with an advantageous embodiment;

FIG. 8 is an illustration of a positioning of parts in a manufacturing environment in accordance with an advantageous embodiment;

FIG. 9 is an illustration of a positioning of parts in a manufacturing environment in accordance with an advantageous embodiment;

FIG. 10 is an illustration of a positioning of parts in a manufacturing environment in accordance with an advantageous embodiment; and

FIG. 11 is an illustration of a flowchart of a process for forming features on parts in accordance with an advantageous embodiment.

### DETAILED DESCRIPTION

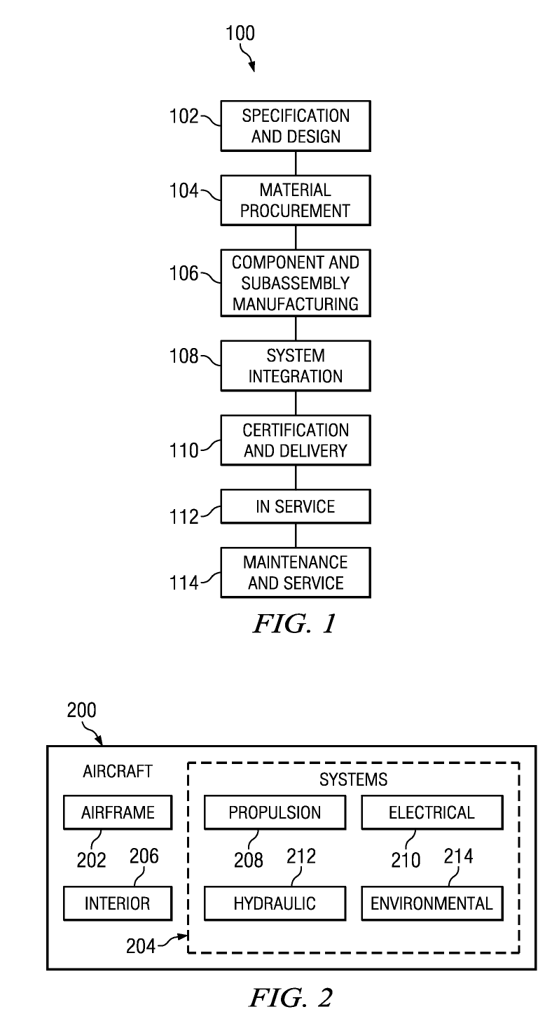

Referring more particularly to the drawings, embodiments of the disclosure may be described in the context of aircraft manufacturing and service method 100 as shown in FIG. 1 and aircraft 200 as shown in FIG. 2. Turning first to FIG. 1, an illustration of an aircraft manufacturing and service method is depicted in accordance with an advantageous embodiment. During pre-production, aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service 112 by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, an illustration of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during at least one of the stages of aircraft manufacturing and service method 100 in FIG. 1. As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C or item B and item C.

In one illustrative example, components or subassemblies produced in component and subassembly manufacturing 106 in FIG. 1 may be fabricated or manufactured in a manner similar to components or subassemblies produced while aircraft 200 is in service 112 in FIG. 1. As yet another example, a number of apparatus embodiments, method embodiments, or a combination thereof may be utilized during production stages, such as component and subassembly manufacturing 106 and system integration 108 in FIG. 1. A number, when referring to items, means one or more items. For example, a number of apparatus embodiments are one or more apparatus embodiments. A number of apparatus embodiments, method embodiments, or a combination thereof may be utilized while aircraft 200 is in service 112 and/or during maintenance and service 114 in FIG. 1. The use of a number of the different advantageous embodiments may substantially expedite the assembly of and/or reduce the cost of aircraft 200.

The different advantageous embodiments recognize and take into account a number of different considerations. For example, without limitation, the different advantageous embodiments recognize and take into account that machines used to create features may have an accuracy that may not be at a desired level for creating features. The different advantageous embodiments recognize and take into account that one manner in which features may be created involves forming features on each part with a fixed position for the parts. In other words, a first part may be held in one position, while a machine performs operations on the part to create the features. A second part may be placed in substantially the same position on the machine, and features are then created by the machine. In other words, the positions of the parts may be fixed in the most convenient position for the machine work envelope. The machine work envelope may be an area in which the machine moves a tool to create features on a part.

The different advantageous embodiments recognize and take into account that with this type of feature creation on parts, features on one part that may match features on another part are generally machined in a different position to that matching part. As a result, the different advantageous embodiments recognize and take into account that two programs may be used to machine these parts. With this type of process, the accuracy in the machine may be a factor in whether tolerances are met for the features on the parts.

The different advantageous embodiments recognize and take into account that the repeatability of forming features on a part may be better than the accuracy in forming the features for a machine. In other words, if holes are drilled in a selected position by the machine, the accuracy of the feature created may fall within one tolerance. For example, the accuracy of forming a feature using a program at a particular point may be one value.

The repeatability of creating a feature in the same position may be a second value. This second value may often be less than the first value. In other words, although the actual position of the feature may be off greater than some desired amount, the actual location where the feature is repeated may be within a smaller tolerance. In other words, the feature may be generated in a location away from the desired or targeted location. This feature, however, may be repeatedly generated in that same position within a smaller tolerance as compared to the accuracy when the same approach with the same number of paths is used to create the features.

Thus, the different advantageous embodiments recognize and take into account that it may be desirable to generate features using the repeatability of creating features by a machine rather than the accuracy.

Thus, the different advantageous embodiments may provide a method and apparatus for processing parts. In one advantageous embodiment, a part may be positioned in a first position. A first number of features may be formed on the first part using a first machine at a number of points for attachment to a second part. The second part may be positioned in a second position relative to the first position for assembly of the first part with the second part. A second number of features may be formed on the second part at the number of points for attachment to the first part using the first machine. In other words, the first number of features and the second number of features may be used for attaching the first part and the second part to each other.

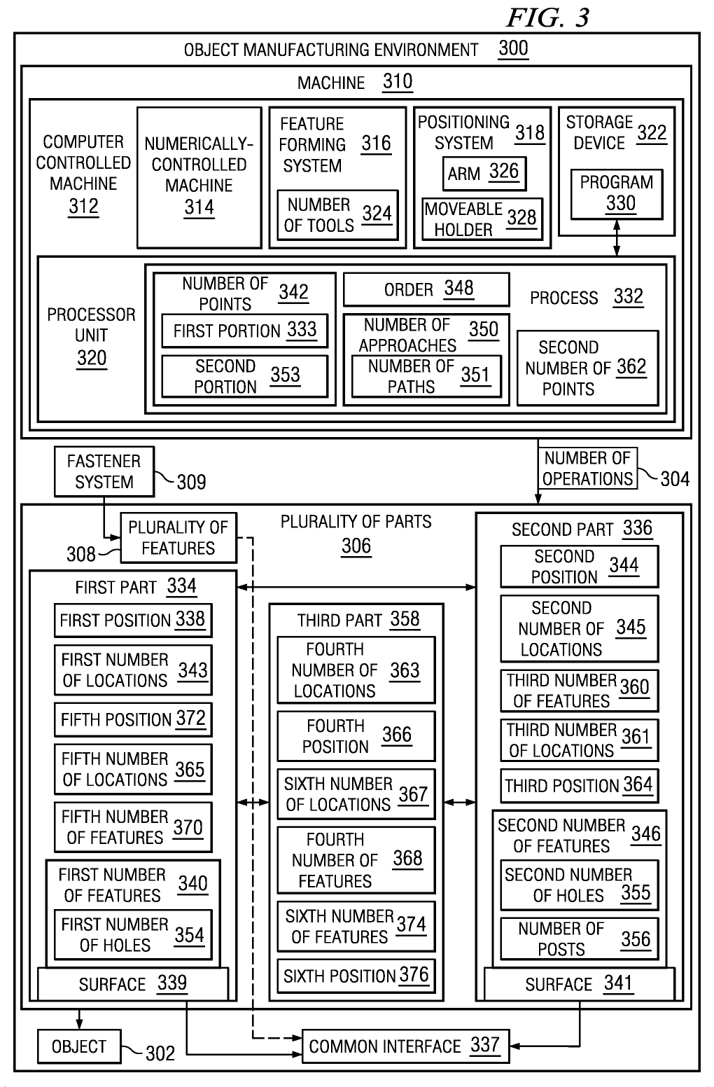

With reference now to FIG. 3, an illustration of an object manufacturing environment is depicted in accordance with an advantageous embodiment. Object manufacturing environment 300 is an example of an environment that may be used to manufacture object 302. Object 302 may be, for example, aircraft 200 and/or some structure used in aircraft 200 in FIG. 2.

In this illustrative example, object manufacturing environment 300 may be used to perform number of operations 304 on plurality of parts 306 to form plurality of features 308 on plurality of parts 306. Each part in plurality of parts 306 may have a number of features in plurality of features 308.

Plurality of features 308 may be used to attach plurality of parts 306 to each other. This attachment of plurality of parts 306 to each other using plurality of features 308 may be performed without using other tooling. In some illustrative examples, plurality of features 308 may be used to align parts for attachment to each other. In other illustrative examples, fastener system 309 may be used in or on plurality of features 308 to attach plurality of parts 306 to each other.

In this illustrative example, plurality of features 308 may be formed on plurality of parts 306 using machine 310. Machine 310 may take a number of different forms. For example, without limitation, machine 310 may be computer controlled machine 312. Computer controlled machine 312 may take the form of numerically-controlled machine 314.

In this illustrative example, computer controlled machine 312 may comprise feature forming system 316, positioning system 318, processor unit 320, and storage device 322. Feature forming system 316 may include number of tools 324. Number of tools 324 may be, for example, without limitation, at least one of a drill, a milling machine, a lathe, or some other suitable type of tool. In these examples, number of tools 324 may be any tool that may be used to form plurality of features 308 on plurality of parts 306.

Positioning system 318 may be used to position and hold plurality of parts 306. Positioning system 318 may include, for example, without limitation, arm 326 and moveable holder 328. Arm 326 may move number of tools 324. Moveable holder 328 may position and hold plurality of parts 306 in different positions relative to number of tools 324 in these illustrative examples.

In this illustrative example, processor unit 320 may be, for example, without limitation, one or more heterogeneous processor systems in which a main processor is present with secondary processors on a single chip. In other advantageous embodiments, processor unit 320 may be a single processor or multiple processors. Any type of processor or device may be used in processor unit 320 that may be capable of controlling computer controlled machine 312 to form plurality of features 308 for plurality of parts 306. In particular, processor unit 320 may be configured to control feature forming system 316 to form plurality of features 308 on plurality of parts 306.

In these illustrative examples, program 330 may be located on storage device 322 and executed by processor unit 320 as process 332. Process 332 may control feature forming system 316 and positioning system 318 to form plurality of features 308 on plurality of parts 306. For example, for parts in plurality of parts 306 having common interface 337, plurality of features 308 may be formed at a same number of points at common interface 337.

In one illustrative example, plurality of parts 306 may include first part 334 and second part 336. In this example, common interface 337 may be the interface at which surface 339 of first part 334 and surface 341 of second part 336 meet. Positioning system 318 may position first part 334 in first position 338. First number of features 340 may be formed on first part 334 using feature forming system 316 for machine 310 at number of points 342. Number of points 342 may correspond to first number of locations 343 on surface 339 of first part 334. In this illustrative example, first number of features 340 may be formed on surface 339 of first part 334.

In these illustrative examples, number of points 342 may be points in a three-dimensional coordinate system in space. For example, without limitation, number of points 342 may be points in a Cartesian coordinate system, a polar coordinate system, or some other suitable coordinate system.

Second part 336 may then be positioned in second position 344. Second position 344 may be relative to first position 338 for assembly of first part 334 with second part 336. After positioning second part 336, second number of features 346 may be formed on second part 336 using feature forming system 316 for machine 310 at number of points 342. Number of points 342 may correspond to second number of locations 345 on surface 341 of second part 336. In this illustrative example, second number of features 346 may be formed on surface 341 of second part 336. First number of features 340 and second number of features 346 may be for attaching first part 334 to second part 336.

In other words, first number of features 340 and second number of features 346 may be used to position first part 334 and second part 336 relative to each other to form an object, such as object 302. In this manner, first number of features 340 and second number of features 346 may be at least substantially aligned to assemble first part 334 with second part 336.

In these illustrative examples, the forming of first number of features 340 and second number of features 346 may be performed at number of points 342. In other words, the features may be formed at substantially the same points by reaching number of points 342 in a similar manner, by repeating the running of program 330, and/or repeating the running of portions of program 330 in machine 310 in these illustrative examples. Of course, a different program may be used, depending on the particular implementation. In some advantageous embodiments, using the same program may increase the accuracy and/or repeatability of forming first number of features 340 and second number of features 346 at number of points 342.

In these illustrative examples, forming first number of features 340 and second number of features 346 at number of points 342 may include forming both first number of features 340 and second number of features 346 using order 348. In other words, first number of features 340 and second number of features 346 may be formed using the substantially same order.

Additionally, the forming of first number of features 340 and second number of features 346 at number of points 342 may be performed using number of approaches 350. In other words, the formation of the features may be made at number of points 342 using the same number of approaches. Number of approaches 350 may be the direction in which first number of features 340 and second number of features 346 may be formed. In this illustrative example, number of approaches 350 may be achieved by machine 310 following number of paths 351. Number of paths 351 may be paths that machine 310 may take to reach number of points 342 using number of approaches 350. In this illustrative example, the forming of first number of features 340 at number of points 342 may be performed along the same number of paths as the forming of second number of features 346 at number of points 342.

In these illustrative examples, first number of features 340 and second number of features 346 may take different forms. For example, without limitation, first number of features 340 may take the form of first number of holes 354, and second number of features 346 may take the form of second number of holes 355. In other advantageous embodiments, first number of features 340 may take the form of first number of holes 354, while second number of features 346 may take the form of number of posts 356. Number of posts 356 may be inserted into first number of holes 354 in these examples.

In these illustrative examples, first part 334 may be assembled with second part 336 using plurality of features 308 in a number of different ways. For example, without limitation, first number of features 340 and second number of features 346 may be used to align first part 334 with second part 336 in preparation for assembling first part 334 with second part 336. Fastener system 309 may then be used to assemble first part 334 with second part 336 in these illustrative examples.

In some advantageous embodiments, an adhesive may be placed on surface 339 of first part 334 and on surface 341 of second part 336. First part 334 may then be aligned with second part 336 using fastener system 309 with first number of features 340 and second number of features 346. When, for example and without limitation, the adhesive at common interface 337 is dry such that first part 334 and second part 336 are attached to each other, fastener system 309 may be removed. In other illustrative examples, fastener system 309 may not be removed. In yet other illustrative examples, the adhesive may be used to attach first part 334 and second part 336 without using fastener system 309.

In other advantageous embodiments, first number of features 340 and second number of features 346 may be used to attach first part 334 and second part 336. In these advantageous embodiments, first number of features 340 and second number of features 346 may be used to align first part 334 with second part 336. Fastener system 309 may then be used to attach first part 334 and second part 336 to each other using first number of features 340 and second number of features 346. In these examples, fastener system 309 may be, for example, without limitation, bolts that are placed in first number of features 340 and second number of features 346.

The relative positioning for forming features may be relative with respect to parts that are attached to each other. For example, third part 358 may be designed for attachment to second part 336 and not first part 334.

In this illustrative example, third number of features 360 may be formed on second part 336 at second number of points 362. Second number of points 362 may correspond to third number of locations 361 on second part 336. Second part 336 may be positioned in second position 344 or may be positioned in third position 364. Third part 358 may be positioned in fourth position 366 relative to third position 364 for an assembly of third part 358 with second part 336. Fourth number of features 368 may then be formed on third part 358 at second number of points 362. Second number of points 362 may correspond to fourth number of locations 363 on third part 358. Fourth number of features 368 and third number of features 360 may be configured for attaching second part 336 and third part 358 to each other. In these illustrative examples, third position 364 may be the same or different from second position 344, depending on the relative position of third part 358 in fourth position 366.

In other advantageous embodiments, machine 310 may be used to form fifth number of features 370 at first portion 333 of number of points 342 on first part 334 in fifth position 372. First portion 333 may be one point in number of points 342, some of number of points 342, or all of number of points 342. Further, first portion 333 may correspond to fifth number of locations 365 on first part 334. In these embodiments, machine 310 then may be used to form sixth number of features 374 on third part 358 in sixth position 376 at second portion 353 of number of points 342. Second portion 353 of number of points 342 may correspond to sixth number of locations 367 on third part 358. Further, in these embodiments, sixth position 376 may be a position relative to fifth position 372 of first part 334 in an assembly of first part 334 and third part 358. Sixth number of features 374 and fifth number of features 370 may be configured for attaching first part 334 and third part 358 to each other.

The illustration of object manufacturing environment 300 in FIG. 3 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in other advantageous embodiments, positioning system 318 may not be part of machine 310. For example, positioning system 318 may be a machine that positions plurality of parts 306. In some advantageous embodiments, positioning system 318 may be a clamping system, a holding system, and/or some other suitable type of positioning system. Positioning system 318 may be controlled by processor unit 320 or some other computer system to position plurality of parts 306. In some advantageous embodiments, positioning system 318 may be operated by a human operator to position plurality of parts 306.

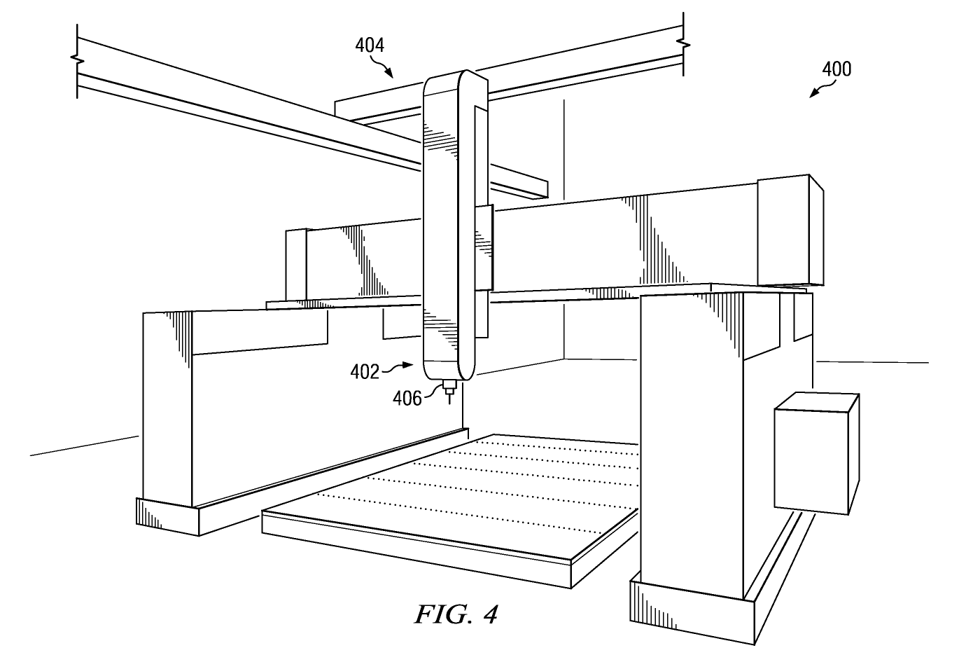

With reference now to FIG. 4, an illustration of a drilling machine is depicted in accordance with an advantageous embodiment. In this illustrative example, drilling machine 400 is an example of one implementation of machine 310 in FIG. 3. In particular, drilling machine 400 may be an example of one implementation of computer controlled machine 312 in FIG. 3.

As depicted, drilling machine 400 may have feature forming system 402 and movement system 404. Feature forming system 402 may be an example of one implementation of feature forming system 316 in FIG. 3. Feature forming system 402 may have drilling tool 406. Drilling tool 406 may be used to drill features in the form of holes in a part. The part may be, for example, without limitation, one of plurality of parts 306 in FIG. 3.

In this illustrative example, movement system 404 may be a movement system configured to move drilling tool 406 along a number of paths to a number of points. This number of paths to the number of points may be used to drill holes into a part. As depicted, movement system 404 may move drilling tool 406 in three-dimensional space.

In these examples, drilling machine 400 may be implemented using, for example, without limitation, the Matrix 1000 High Speed Vertical Machining Center available from Breton SPA, the IRB 6600 robot available from the ABB Group, or the Ramspeed RH Plus available from Rambaudi SPA.

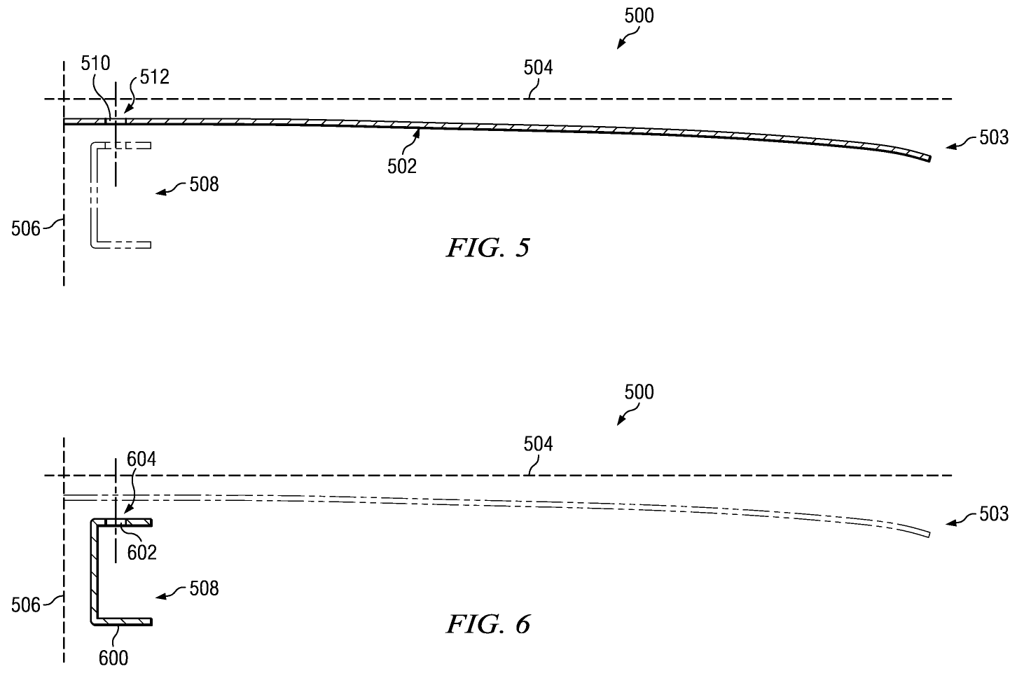

With reference now to FIG. 5, an illustration of a positioning of parts in a manufacturing environment is depicted in accordance with an advantageous embodiment. In this illustrative example, manufacturing environment 500 may be an example of one implementation of a portion of object manufacturing environment 300 in FIG. 3. Manufacturing environment 500 may include skin 502. Skin 502 may be an example of one implementation of first part 334 in FIG. 3.

As depicted, skin 502 may be in position 503. In this illustrative example, position 503 may be a position with respect to horizontal axis 504, vertical axis 506, and/or other axes not depicted in this view. Position 508 may be a position of a second part (not shown in this view) in which the position of the second part is relative to position 503 in an assembly of skin 502 with the second part.

In this illustrative example, feature 510 may be a feature that may be formed on skin 502 with a machine, such as machine 310 in FIG. 3. Feature 510 may be formed at location 512 on skin 502. In this depicted example, feature 510 may be a hole.

With reference now to FIG. 6, an illustration of a positioning of parts in a manufacturing environment is depicted in accordance with an advantageous embodiment. In this illustrative example, manufacturing environment 500 from FIG. 5 is depicted without skin 502. The second part, spar 600, is shown in position 508. As depicted, spar 600 may be in position 508 relative to position 503. Position 503 may be the position of skin 502 in FIG. 5. Position 508 of spar 600 may be a position relative to position 503 in an assembly of spar 600 with skin 502 in FIG. 5.

In this illustrative example, feature 602 may be formed on spar 600 by machine 310 in FIG. 3. As depicted, feature 602 may be formed at location 604 on skin 602. Location 604 and location 512 in FIG. 5 may correspond to a point in a number of points, such as number of points 342 in FIG. 3. In this illustrative example, machine 310 may reach location 604 and location 512 using the same approach to increase the repeatability of feature 510 and feature 602. This point may be a point in a three-dimensional coordinate system in space. In this depicted example, feature 602 may be a hole.

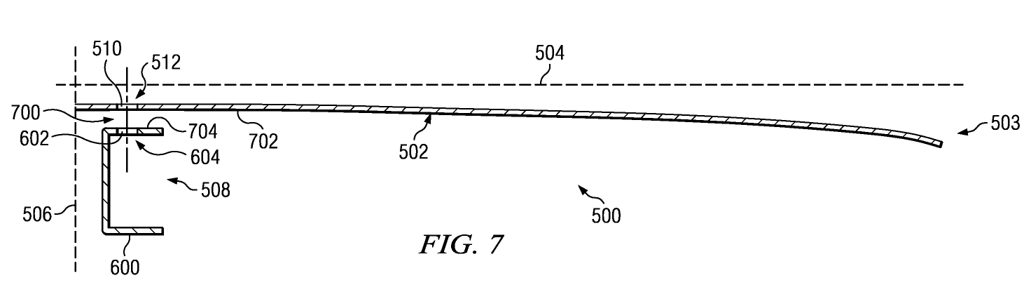

With reference now to FIG. 7, an illustration of a positioning of parts in a manufacturing environment is depicted in accordance with an advantageous embodiment. In this illustrative example, manufacturing environment 500 from FIGS. 5 and 6 is depicted with skin 502 in position 503 and spar 600 in position 508. Both skin 502 and spar 600 may be depicted in this view to illustrate that location 512 of feature 510 and location 604 of feature 602 may correspond to the same point in a three-dimensional coordinate system. This point may be point 700 as depicted in this example. As one illustrative example, a machine, such as drilling machine 400 in FIG. 4, may be used to drill a hole for feature 510 at point 700 corresponding to location 512 on skin 502. Drilling machine 400 also may be used to drill a hole for feature 602 at point 700 corresponding to location 604 on spar 600.

In this illustrative example, when skin 502 and spar 600 are attached to each other, surface 702 of skin 502 and surface 704 of spar 600 may form an interface at which feature 510 and feature 602 are located, respectively. Feature 510 and feature 602 may be matched within a desired tolerance due to the repeatability in the forming of the features.

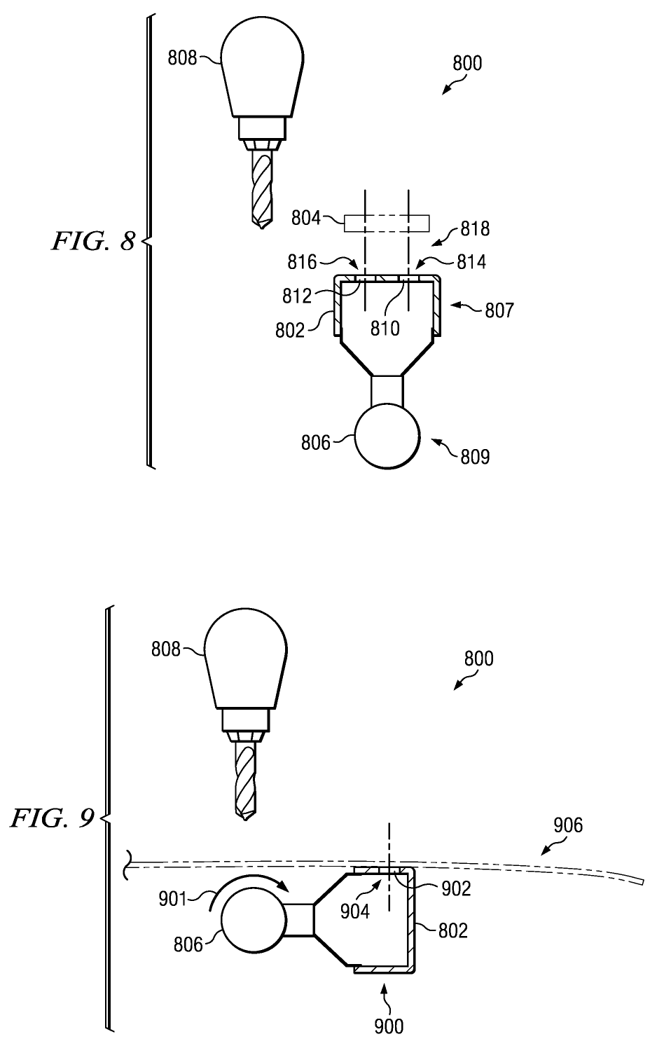

With reference now to FIG. 8, an illustration of a positioning of parts in a manufacturing environment is depicted in accordance with an advantageous embodiment. In this illustrative example, manufacturing environment 800 may be an example of one implementation of a portion of object manufacturing environment 300 in FIG. 3. Manufacturing environment 800 may include spar 802, cleat 804, positioning system 806, and drilling machine 808.

In this illustrative example, spar 802 may be an example of one implementation of first part 334 in FIG. 3. Spar 802 may be positioned in position 807 by positioning system 806. In this depicted example, positioning system 806 may be an example of one implementation of positioning system 318 in FIG. 3. However, as depicted, positioning system 806 may not be part of drilling machine 808. Positioning system 806 may take the form of flexible positioning system 809 in this illustrative example. Flexible positioning system 809 may be configured to move spar 802 into a number of different positions. Flexible positioning system 809 may be implemented using, for example, without limitation, an F-100iA Fixturing System, which may be available from Fanuc Robotics America Incorporated. Flexible positioning system 809 also may be implemented using a Flex-PLP fixturing system, which may be available from the ABB Group. In other advantageous embodiments, flexible positioning system 809 may be implemented using a robot, a holder, or some other suitable type of machine.

In this depicted example, position 807 may be a position selected to allow drilling machine 808 to form features on spar 802. Drilling machine 808 may be used to form feature 810 at location 814 and feature 812 at location 816 on spar 802. These locations may correspond to number of points 818 in a three-dimensional coordinate system. Drilling machine 808 may be programmed to move along a number of paths to number of points 818 to form, for example, without limitation, feature 810 and feature 812.

Feature 810 and feature 812 may be holes in this example. Further, feature 810 and feature 812 may be holes that may be at least substantially aligned with a number of features that may be formed on cleat 804.

As depicted, cleat 804 may be seen positioned relative to position 807 of spar 802 for an assembly of spar 802 and cleat 804. In this illustrative example, drilling machine 808 may form feature 810 and feature 812 on spar 802 with cleat 804 not positioned over spar 802. However, feature 810 and feature 812 may be formed using the same number of points and the same number of approaches.

With reference now to FIG. 9, an illustration of a positioning of parts in a manufacturing environment is depicted in accordance with an advantageous embodiment. In this illustrative example, manufacturing environment 800 from FIG. 8 is depicted with spar 802 in position 900. Positioning system 806 may be rotated in the direction of arrow 901 to move spar 802 into position 900 from position 807 in FIG. 8.

In this illustrative example, drilling machine 808 may be used to form feature 902 at location 904 on spar 802. Feature 902 may be a hole in this example. Location 904 may correspond to a first portion of number of points 818 at which drilling machine 808 may be programmed to drill holes. As depicted, position 906 may be a position of an upper skin (not shown in this view) that may be assembled with spar 802 using feature 902. The upper skin may be drilled by drilling machine 808 to form features using the substantially same order and the substantially same approach used to form feature 902.

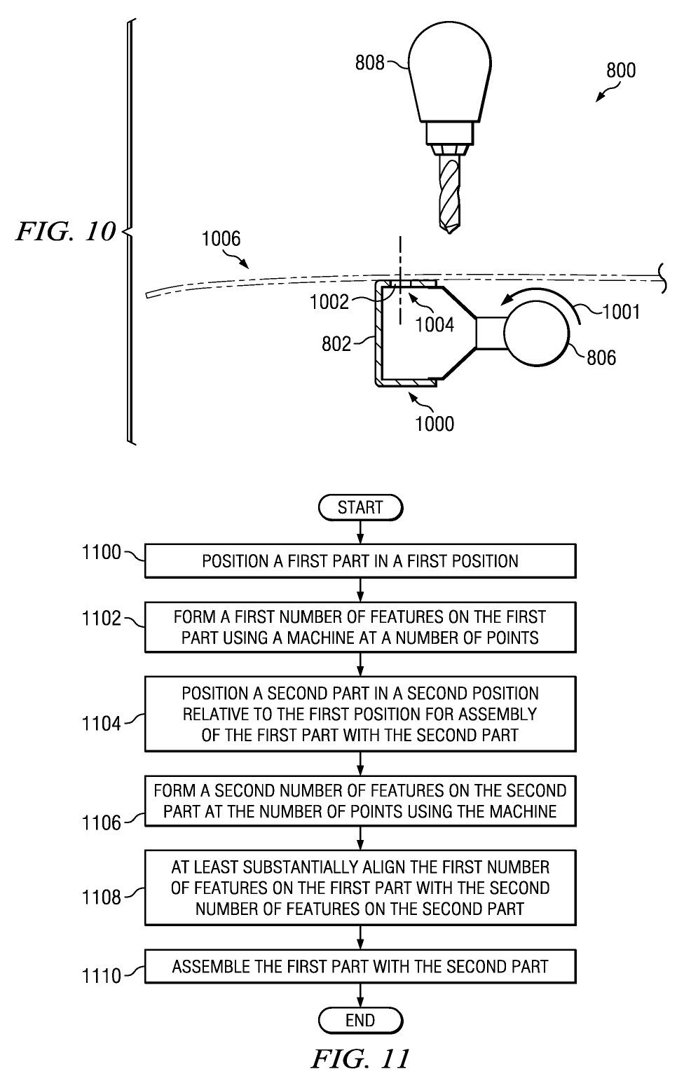

With reference now to FIG. 10, an illustration of a positioning of parts in a manufacturing environment is depicted in accordance with an advantageous embodiment. In this illustrative example, manufacturing environment 800 is depicted with spar 802 in position 1000. Positioning system 806 may be rotated in the direction of arrow 1001 to move spar 802 into position 1000 from either position 807 in FIG. 8 or position 900 in FIG. 9.

In this illustrative example, drilling machine 808 may be used to form feature 1002 at location 1004 on spar 802. Feature 1002 may be a hole in this example. Location 1004 may correspond to a second portion of number of points 818 in FIG. 8 at which drilling machine 808 may be programmed to drill holes. As depicted, position 1006 may be a position of a lower skin (not shown in this view) that may be assembled with spar 802 using feature 1002. The lower skin may be drilled by drilling machine 808 to form features using the substantially same order and the substantially same approach used to form feature 1002.

As depicted in FIGS. 8-10, drilling machine 808 may be programmed to drill a number of holes at number of points 818. Positioning system 806 may be used to position spar 802 in different positions, depending on the different portions of number of points 818 at which the features may be formed on spar 802. By using a single drilling machine running a single program, such as program 330 in FIG. 3, repeatability may be achieved.

In other words, drilling machine 808 may be programmed to drill holes at substantially the same number of points using substantially the same number of approaches in a three-dimensional coordinate system in each of the configurations of manufacturing environment 800 in FIGS. 8-10. The different features formed on spar 802 to align with cleat 804, the upper skin, and the lower skin may be formed with drilling machine 808 following a substantially same order and/or number of paths to number of points 818. In this manner, repeatability within a desired tolerance for drilling machine 808 may be achieved.

With reference now to FIG. 11, an illustration of a flowchart of a process for forming features on parts is depicted in accordance with an advantageous embodiment. The process illustrated in FIG. 11 may be implemented in object manufacturing environment 300 in FIG. 3.

The process may begin by positioning first part 334 in first position 338 (operation 1100). First part 334 may be positioned by positioning system 318. The process may then form first number of features 340 on first part 334 using machine 310 at number of points 342 (operation 1102). Number of points 342 may correspond to first number of locations 343 on first part 334.

Thereafter, the process may position second part 336 in second position 344 relative to first position 338 for assembly of first part 334 with second part 336 (operation 1104). Second part 336 may be positioned by positioning system 318. The process may then form second number of features 346 on second part 336 at number of points 342 using machine 310 (operation 1106). Number of points 342 may correspond to second number of locations 345 on second part 336.

Thereafter, the process may at least substantially align first number of features 340 on first part 334 with second number of features 346 on second part 336 (operation 1108). The process may then assemble first part 334 with second part 336 (operation 1110), with the process terminating thereafter. In these illustrative examples, first part 334 may be assembled with second part 336 using, for example, without limitation, fastener system 309.

The flowchart and block diagrams in the different depicted embodiments illustrate the architecture, functionality, and operation of some possible implementations of apparatus and methods in different advantageous embodiments. In this regard, each block in the flowchart or block diagrams may represent a module, segment, function, and/or a portion of an operation or step.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

Thus, the different advantageous embodiments provide a method and apparatus for processing parts by forming features on the parts. In one advantageous embodiment, a part may be positioned in a first position. A first number of features may be formed on the first part using a first machine at the number of points. A second part may be positioned in a second position relative to the first position for assembly of the first part with the second part. A second number of features may be formed on the second part at the number of points using the first machine. The first number of features and the second number of features may be configured for attaching the first part and the second part to each other.

The description of the different advantageous embodiments has been presented for purposes of illustration and description, and it is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for processing parts, the method comprising:
positioning a first part in a first position;
forming a first number of features on the first part using a feature forming system at a number of points for attachment to a second part;
positioning the second part in a second position relative to the first position for assembly of the first part with the second part; and
forming a second number of features on the second part at the number of points for attachment to the first part using the feature forming system.

2. The method of claim 1, wherein the step of forming the first number of features on the first part using the feature forming system at the number of points comprises:
forming the first number of features on the first part using the feature forming system for attachment to the second part using a number of paths to the number of points, and wherein the step of forming the second number of features on the second part at the number of points using the feature forming system comprises:
forming the second number of features on the second part using the feature forming system for attachment to the first part using the number of paths to the number of points.

3. The method of claim 1, wherein the step of forming the first number of features on the first part using the feature forming system at the number of points comprises:
forming the first number of features on the first part for attachment to the second part using the feature forming system using a number of approaches to the number of points, and wherein the step of forming the second number of features on the second part at the number of points using the feature forming system comprises:
forming the second number of features on the second part for attachment to the first part using the feature forming system using the number of approaches to the number of points, wherein the first number of features and the second number of features are configured for attaching the first part and the second part to each other.

4. The method of claim 1, wherein the second number of features is formed at the number of points in a substantially same order and a substantially same number of approaches as the first number of features formed at the number of points.

5. The method of claim 1 further comprising:
positioning the second part in a third position;
forming a third number of features on the second part at a second number of points for attachment to a third part;
positioning a third part in a fourth position relative to the third position of the second part; and
forming a fourth number of features on the third part at the second number of points for attachment to the second part using a substantially same order and a substantially same number of approaches to the second number of points as used to create the third number of features.

6. The method of claim 1 further comprising:
positioning the first part in a fifth position;
forming a fifth number of features on the first part at a portion of the number of points for attachment to a third part;
positioning a third part in a sixth position relative to the fifth position for assembly of the first part with the third part; and
forming a sixth number of features on the third part at a second portion of the number of points for attachment to the first part a substantially same order and a substantially same number of approaches to reach the number of points as used to create the fifth number of features.

7. The method of claim 1, wherein the first part and the second part are positioned using a positioning system.

8. The method of claim 1, wherein the feature forming system comprises at least one of a drilling machine, a milling machine, and a lathe.

9. The method of claim 1, wherein the first number of features is a first number of holes and the second number of features is a second number of holes.

10. The method of claim 1, wherein running at least a portion of a computer-based program is repeated to form the first number of features and the second number of features.

11. The method of claim 1, wherein the first part and the second part are for a structure in a platform selected from one of a mobile platform, an aircraft, a spacecraft, a space station, and a satellite.

12. A method for processing parts for an aircraft, the method comprising:
positioning a first part for the aircraft in a first position using a positioning system;
forming a first number of features on the first part at a number of points using a feature forming system controlled using a computer-based program and a number of paths to the number of points;
positioning a second part for the aircraft in a second position relative to the first position for assembly of the first part with the second part using the positioning system; and
forming a second number of features on the second part at the number of points using the feature forming system controlled using the computer-based program and the number of paths to the number of points in which the first number of features and the second number of features are for attaching the first part and the second part to each other, in which the second number of features is formed at the number of points in a substantially same order as the first number of features formed at the number of points.

13. The method of claim 12 further comprising:
positioning the second part in a third position using the positioning system;
forming a third number of features on the second part at a second number of points using the feature forming system controlled using the computer-based program and a second number of paths to the second number of points;
positioning a third part in a fourth position relative to the third position of the second part using the positioning system; and
forming a fourth number of features on the third part at the second number of points using the feature forming system and the second number of paths to the second number of points, wherein the third number of features and the fourth number of features are for attaching the second part and the third part to each other.

14. The method of claim 12 further comprising:
removing the first part prior to forming the second number of features on the second part at the number of points.

15. The method of claim 12, wherein the feature forming system comprises at least one of a drilling machine, a milling machine, and a lathe, and in which the first number of features and the second number of features are comprised of a number of holes.

16. An apparatus comprising:
a positioning system configured to position a first part in a first position and configured to position a second part in a second position in which the second position is relative to the first position for assembly of the first part with the second part; and
a feature forming system configured to form a first number of features on the first part at a number of points when the first part is in the first position and to form a second number of features on the second part at the number of points when the second part is in the second position in which the first number of features and the second number of features are configured for attaching the first part and the second part to each other.

17. The apparatus of claim 16, wherein in forming the first number of features, the feature forming system forms the first number of features on the first part using the feature forming system using a number of paths to the number of points and wherein in forming the second number of features on the second part, the feature forming system forms the second number of features on the second part using the feature forming system and the number of paths to the number of points, wherein the first number of features and the second number of features are configured for attaching the first part and the second part to each other.

18. The apparatus of claim 16, wherein the positioning system is configured to position the second part in a third position and position a third part in a fourth position relative to the third position for assembly of the second part and the third part and wherein the feature forming system forms a third number of features on the second part at a second number of points and forms a fourth number of features on the third part at the second number of points, wherein the third number of features and the fourth number of features are configured for attaching the second part and the third part to each other.

19. The apparatus of claim 16, wherein the feature forming system is configured to use a number of paths to the number of points to form the first number of features and the number of paths to the number of points to form the second number of features.

20. The apparatus of claim 16, wherein the feature forming system is configured to use a number of approaches to the number of points to form the first number of features and the number of approaches to the number of points to form the second number of features.

21. The apparatus of claim 16, wherein the feature forming system comprises at least one of a drilling machine, a milling machine, and a lathe.

22. The apparatus of claim 16, wherein the first number of features is a first number of holes and the second number of features is a second number of holes.

23. The apparatus of claim 16, wherein a repeated sequence of machine events is used to form the first number of features and the second number of features.

24. The apparatus of claim 16, wherein the first part and the second part are for a structure in a platform selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a manufacturing facility, and a building.

25. An apparatus for forming features for determinant assembly of parts for an aircraft, the apparatus comprising:
a positioning system configured to position a first part for the aircraft in a first position and configured to position a second part for the aircraft in a second position in which the second position is relative to the first position for assembly of the first part with the second part; and
a feature forming system configured to form a first number of features on the first part at a number of points using a number of paths to the number of points when the first part is in the first position and to form a second number of features on the second part at the number of points using the number of paths to the number of points when the second part is in the second position in which the first number of features and the second number of features are configured for attaching the first part and the second part to each other in which the feature forming system comprises at least one of a drilling machine, a milling machine, and a lathe, and in which the first number of features and the second number of features are comprised of a number of holes.

26. The apparatus of claim 25, wherein the positioning system is configured to position the second part in a third position and position a third part in a fourth position relative to the third position for assembly of the second part and the third part and wherein the feature forming system forms a third number of features on the second part at a second number of points using a second number of paths to the second number of points and forms a fourth number of features on the third part at the second number of points using the second number of paths to the second number of points in which the third number of features and the fourth number of features are configured for attaching the second part and the third part to each other.
